(19) United States
(12) Patent Application Publication
(10) Pub. No.: US 2008/0262936 A1
(43) Pub. Date: Oct. 23, 2008

(54) Method And System For Fueling

(75) Inventors: Margaretha Simonia Paardekooper, Leiden (NL); Richard Rensman, Utrecht (NL); Arjan Dirk Harm Rooyens, The Hague (NL); Wieger Sanne Vos, Amsterdam (NL)

Correspondence Address: MICHAELSON & ASSOCIATES, P.O. BOX 8489, RED BANK, NJ, 07701-8489, US

(73) Assignee: Koninklijke KPN N.V., The Hague (NL)

(21) Appl. No.: 11/792,187

(22) PCT Filed: Dec. 27, 2005
(86) PCT No.: PCT/EP2005/014186

§ 371 Date: Mar. 11, 2008

Related U.S. Application Data
(60) Provisional application No. 60/639,880, filed on Dec. 29, 2004.

(51) Int. Cl. G06F 19/00; G06Q 20/00; H04M 3/00

(52) U.S. Cl. 705/21; 455/420

(57) ABSTRACT

Method and system for fueling, whereby a fuel pump is released by obtaining a code using a mobile phone and entering that code manually in the fuel pump.

### FIELD OF THE INVENTION

The invention relates to a method and a system for fueling. More specifically, the invention relates to a method and system for releasing a fuel pump.

### BACKGROUND OF THE INVENTION

Payments for fueling are normally made by paying at a cashier using money, bankcard or credit card. A more advanced way of fueling is to release a fuel pump by paying at the fuel pump prior to using the fuel pump, whereby the fuel pump is released by inserting a bankcard or credit card in the fuel pump and paying in advance a certain amount of money using the bankcard or credit card.

A system for establishing automatic access to fuel upright and method for filling up of a vehicle is described in WO98/54678. The system for establishing automatic access to a fuel pump comprises a decentral control unit which regulates fuel pumps associated with a service station, and a central control unit. The control units are activated by wireless signals transmitted from a mobile telephone. A first unique code belonging to the mobile telephone is linked with the identification number of the same telephone, and a number and/or code is linked with data lying in the unit. The decentral control unit links together a second code, which is unique for the fuel pump and which is entered via the telephone, with the status associated with the pump, which is activated by the wireless signals transmitted from the mobile telephone.

A disadvantage of the system of WO98/54678 is that the mobile telephone needs to be able to interact with the fuel pump, either directly or indirectly via intermediate systems.

### Problem Definition

The prior art fails to provide a solution for fueling whereby payments can be made using a mobile telephone without the mobile telephone interacting with the fuel pump.

### Aim of the Invention

It is the aim of the invention to provide a method and a system for fueling whereby payments can be made using a mobile telephone without the mobile telephone interacting with the fuel pump.

### SUMMARY OF THE INVENTION

The present invention provides a solution for fueling whereby payments can be made using a mobile telephone without the mobile telephone interacting with the fuel pump.

According to an aspect of the invention a method and a system are provided for releasing a fuel pump. The method can comprise the following steps or a subset of the following steps, where the system can comprise means to handle these steps: transmitting a first code from a mobile phone to a control system; checking in the control system a balance of a user associated with the mobile phone; generating in the control system a second code; transmitting the second code from the control system to the mobile phone; receiving in a fuel pump via a keypad in the fuel pump the second code; transmitting the second code from the fuel pump to the control system; transmitting a validity confirmation from the control system to the fuel pump; and releasing the fuel pump for usage. This has the advantage that the second code to release the fuel pump can be acquired and paid for using a mobile phone, while the second code can be entered manually in the fuel pump. The method can further comprise the steps of receiving the first code from the mobile phone in a voice response system; and transmitting the first code from the voice response system to the control system. This has the advantage that a user of a mobile phone can be guided by voice for acquiring the second code.

According to an aspect of the invention a control system is provided for use in the system for releasing a fuel pump as described above. The control system advantageously enables generating the second code and providing the second code to the user of the mobile phone on the one hand, and checking the validity of the second code after it has been manually entered in the fuel pump on the other hand.

The invention is not limited to fuel pumps. The invention can also be used to release other type of pumps, like water pumps. Moreover the invention can be used as a payment method at vending machines.

### BRIEF DESCRIPTION OF THE DRAWINGS

The invention will be explained in greater detail by reference to exemplary embodiments shown in the drawings, in which:

FIG. 1 shows the operation of a system according to the invention.

### DETAILED DESCRIPTION OF THE INVENTION

The invention provides a new system for filling up your vehicle at a fuel station without paying with a card or with cash. A central control system is needed that can be activated by means of a wireless telephone and is able to release a given fuel pump. In this control system is the administration of clients, phone numbers, personal codes and their balances.

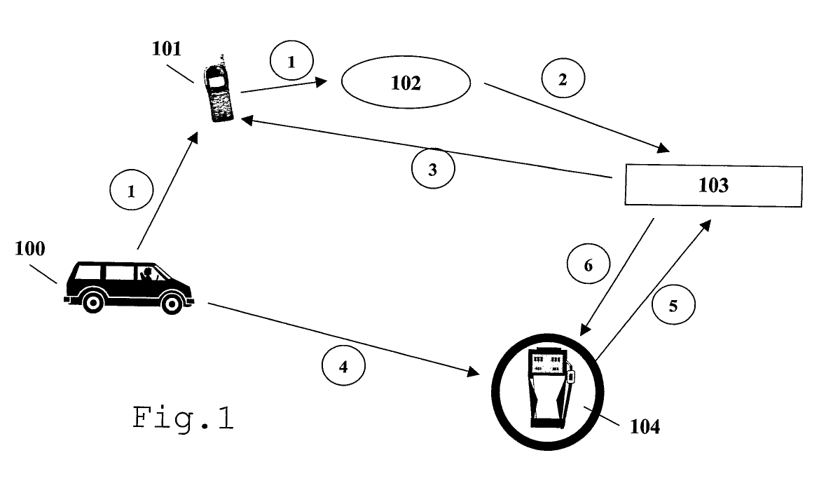

In FIG. 1 the operation of the system is described in the following six steps. It is not described how the administration of clients works. It is assumed that a user is known in the system together with his telephone number and a personal code (pin) and he is allowed to fill up his vehicle (100), (i.e. he has a positive balance).

### 1. User Calls IVR-Number

The user calls a number using a mobile telephone (101) and is connected to an interactive voice response system IVR (102). The user is requested to enter his personal pin code.

### 2. Authentication by Personal Code

The IVR passes on the identification code of the telephone (the phone number) together with the entered personal code to the central control system (103). The system checks if this combination is valid. If not, a signal is transmitted to the IVR so that the user is informed of the invalidity of the data.

### 3. Balance—Check and Provision of Voucher

After the authentication check the balance of the user is checked. If it is insufficient the IVR is triggered to inform the user. If the balance is sufficient a new code (2^{nd} code) will be generated by the system and sent to the user's telephone by SMS. This code will act as a voucher. The provision of the 2^{nd} code can take place before the user has reached the fuel station, so that there is no need to call with his mobile telephone at the fuel station. The method is secure, because only the user himself has received this 2^{nd} code. The code will remain active for a certain amount of time, e.g. half an hour.

### 4. User Enters Voucher at Fuel Pump

At reaching the fuel station, the user enters the 2^{nd} code that he has received at the keypad of the fuel pump (104).

### 5. Check if Voucher is Valid

The fuel pump (104) will pass on the code that is entered to the central control system (103). The system checks the validity of the code. This means that by this code the central control system will recognize the user.

### 6. Fuel Pump is Released

If the entered code is valid, the code will be blocked, the transaction is administered and a signal will be passed on to the fuel pump so that it is released for usage. After usage the fuel pump will transmit the result, i.e. the amount of liters and the price.

The invention is not limited to fuel pumps. The invention can also be used to release other type of pumps, like water pumps. Moreover the invention can be used as a payment method at vending machines.

1: Method for releasing a fuel pump, the method comprising the steps of
transmitting a first code from a mobile phone to a control system;
checking in the control system a balance of a user associated with the mobile phone;
generating in the control system a second code;
transmitting the second code from the control system to the mobile phone;
receiving in a fuel pump via a keypad in the fuel pump the second code;
transmitting the second code from the fuel pump to the control system;
transmitting a validity confirmation from the control system to the fuel pump; and
releasing the fuel pump for usage.

2: Method according to claim 1, the method further comprising the steps of
receiving the first code from the mobile phone in a voice response system; and
transmitting the first code from the voice response system to the control system.

3: System for releasing a fuel pump, the system comprising a mobile phone, a control system and a fuel pump, the control system being linked to the mobile phone and the control system being linked to the fuel pump, whereby
the mobile phone comprises means for transmitting a first code to the control system, the mobile phone further comprises means for receiving a second code from the control system,
the control system comprises means for receiving the first code from the mobile phone, the control system further comprises means for checking a balance of a user associated with the mobile phone, the control system further comprises means for generating the second code and transmitting the second code to the mobile phone, the control system further comprises means for receiving the second code from the fuel pump, the control system further comprises means for transmitting a validity confirmation to the fuel pump,
the fuel pump comprises means for receiving the second code via a keypad in the fuel pump, the fuel pump further comprises means for transmitting the second code to the control system, the fuel pump further comprises means for receiving the validity confirmation from the control system, the fuel pump further comprises means for releasing the fuel pump for usage.

4: System according to claim 3, the system further comprising a voice response system, whereby
the mobile phone comprises means for transmitting the first code to the voice response system,
the control system comprises means for receiving the first code from the voice response system,
the voice response system comprises means for receiving the first code from the mobile phone, the voice response system further comprises means for transmitting the first code to the control system.

5: Control system for use in a system for releasing a fuel pump, the control system being linked to a mobile phone and the control system being linked to a fuel pump, whereby
the control system comprises means for receiving a first code from the mobile phone, the control system further comprises means for checking a balance of a user associated with the mobile phone, the control system further comprises means for generating a second code and transmitting the second code to the mobile phone, the control system further comprises means for receiving the second code from the fuel pump, the control system further comprises means for transmitting a validity confirmation to the fuel pump.

6: Control system according to claim 5, whereby the control system further comprises means for receiving the first code from a voice response system.
